(19) United States
(12) Patent Application Publication
(10) Pub. No.: US 2023/0404308 A1
(43) Pub. Date: Dec. 21, 2023

(54) DUAL ACCESS IN-WALL STORAGE BOX

(71) Applicant: Cheri Balding, South Salt Lake, UT (US)

(72) Inventor: Cheri Balding, South Salt Lake, UT (US)

(21) Appl. No.: 18/208,403

(22) Filed: Jun. 12, 2023

Related U.S. Application Data
(60) Provisional application No. 63/353,532, filed on Jun. 17, 2022.

(51) Int. Cl. A47G 29/14; E06B 7/32

(52) U.S. Cl. CPC A47G 29/14; E06B 7/32

(57) ABSTRACT

A storage box may be installed in an exterior wall of the building. The storage box provides a secured storage receptacle within the wall. The storage box includes doors on both sides of the wall to allow a person to access items stored in the storage box from either inside or outside of the building.

### PRIORITY

The present application claims the benefit of U.S. Provisional Application Ser. No. 63/353,532, filed Jun. 17, 2022, which is herein incorporated by reference in its entirety.

### THE FIELD OF THE INVENTION

The present invention relates to secure storage. In particular, examples of the present invention relate to an in-wall storage box.

### INTRODUCTION

There are situations where people want to store personal items securely and have those items available from multiple locations. The present invention provides a secure storage compartment which allows a person to access the stored items from two different locations, such as from inside of a building and outside of a building or from inside of two adjacent rooms of a building.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a perspective view drawing of a storage box.

FIG. 2 is another perspective view drawing of a storage box of FIG. 1.

FIG. 3 is another perspective view drawing of a storage box of FIG. 1.

FIG. 4 is a side view drawing of the storage box of FIG. 1 installed in a building wall.

Corresponding reference characters indicate corresponding components throughout the several views of the drawings. Unless otherwise noted, the drawings have been drawn to scale. Skilled artisans will appreciate that elements in the figures are illustrated for simplicity and clarity. For example, the dimensions of some of the elements in the figures may be exaggerated relative to other elements to help improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples. It is appreciated that the figures provided herewith are for explanation purposes to persons ordinarily skilled in the art.

As used herein, “adjacent” refers to near or close sufficient to achieve a desired effect. Although direct contact is common, adjacent can broadly allow for spaced apart features.

As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be such as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a number or numerical range endpoint by providing that a given value may be one or two significant figures above or one or two significant figures below the number or endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Dimensions, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

The disclosure particularly describes an in-wall storage box which provides a secure storage location which is also isolated form the environment. The storage box is installed in a building wall and may be accessed from both sides of the wall, allowing for both inside and outside access.

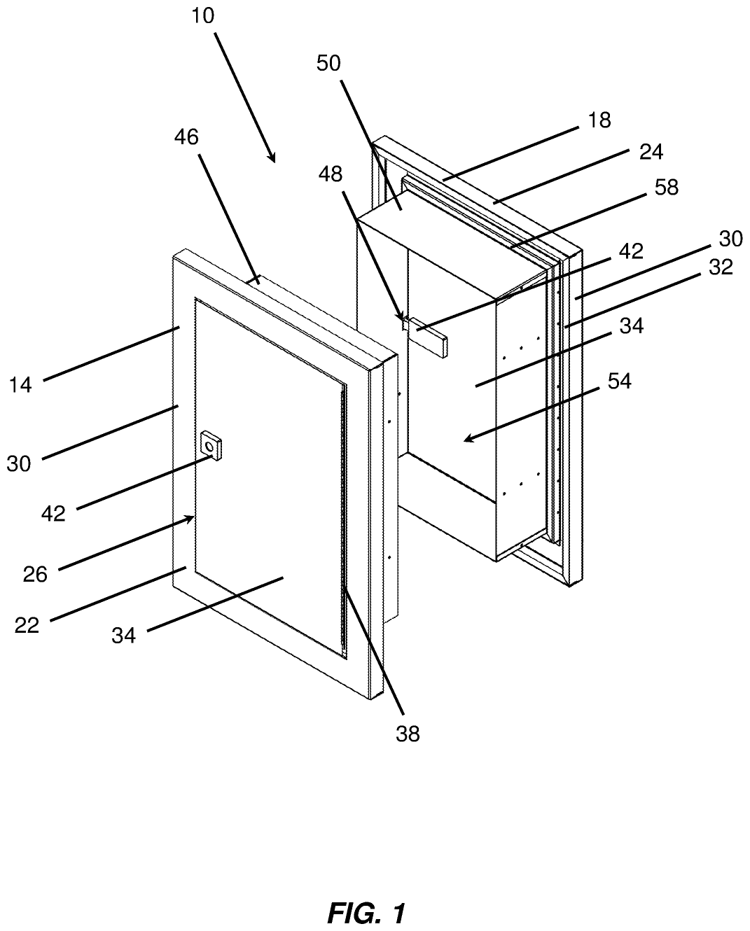

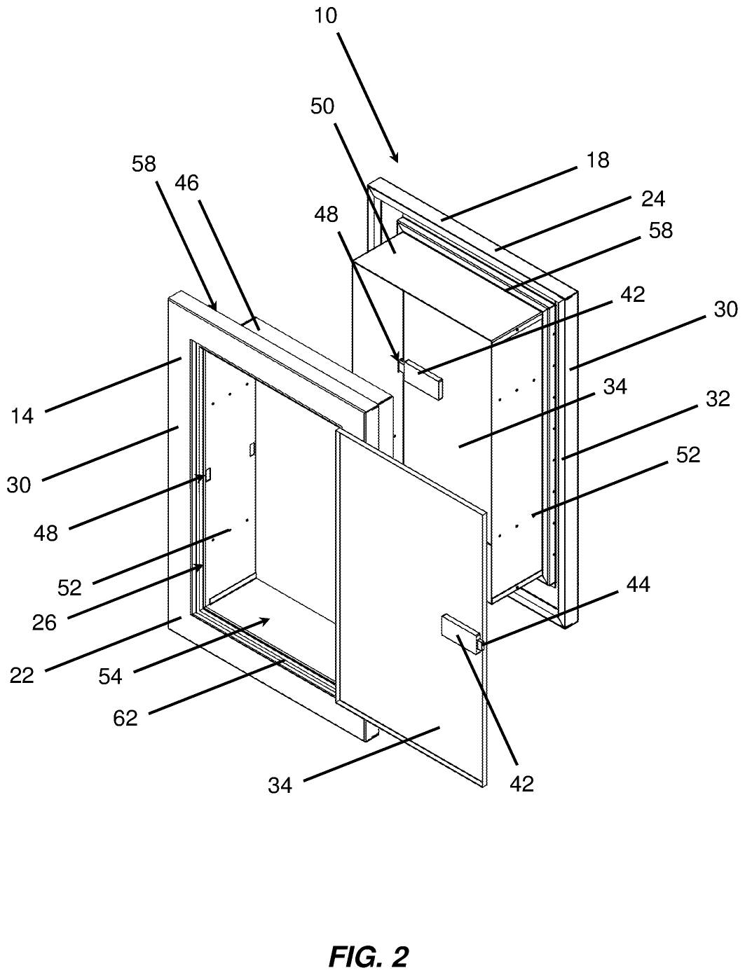

FIGS. 1 and 2 show perspective views of a locking storage box 10 before installation of the locking storage box 10 in a building wall. FIG. 1 shows the storage box 10 with a door 34 closed and FIG. 2 shows the storage box 10 with the door 34 open. The example storage box 10 is fabricated from bent pieces of sheet metal. The storage box 10 includes a first, front half 14 and a second, rear half 18 which join together to form the completed storage box 10. The first half 14 and the second half 18 of the storage box 10 are inserted into an opening in a wall from opposite sides of the wall and joined together while in the wall to assemble the storage box 10. The front storage box half 14 includes a front face 22 and a storage compartment sidewall 46 that extends inwardly (rearwardly) from the back side of the front face 22. The rear storage box half 18 includes a rear face 24 and a storage compartment sidewall 50 that extends inwardly (rearwardly) from the back side of the rear face 24.

The front face 22 and the rear face 24 each include a frame 30 that extends around an opening 26, and a door 34 which is attached to the frame 30 by a length of piano hinge 38. Each frame 30 is formed form sheet metal and includes a flat portion of metal that surrounds the door 34 and forms a portion of the storage box outer face. The example frames 30 are formed to create a door opening 26 and a recessed flange around the door opening 26 that receives the door 34 and blocks access to the interior of the storage box 10 when the door 34 is closed. The outer edges of the example frames 30 are bend backwardly away from the face and are then bent inwardly to form a side edge and an inner surface 32 that abuts the wall when the storage box 10 is installed into a wall. The front face 22 and rear face 24 are generally flat.

The doors 34 provide access to the storage compartment 54 via the openings 26. The doors 34 are attached to the frame 30 by hinges 38 such as piano hinges 38. The doors 34 are positioned within the openings 26 adjacent the opening recesses flange so that the front of the doors 34 is generally flush with the face of the storage box 10. The doors 34 each include a lock 42 such as a key lock or digital lock which is used to secure the door 34 in a closed configuration and to selectively allow access to the storage compartment within the storage box 10. The lock 42 includes a lock tongue 44 that extends from the lock body and which extends through an opening 48 in the storage box side walls 46, 50 to secure the door 34 in a closed position.

The first box half 14 and the second box half 18 both include rectangular side walls 46, 50 which extend inwardly away from the inside sides of the front face 22 and rear face 24. The side walls 46, 50 may be formed in sections from the same pieces of metal that forms sections of the frame 30, or may be formed from separate pieces of metal that are attached to the back side of the frames 30. The first half side walls 46 and the second half side walls 50 are telescoping with each other. The first half side wall 46 forms a rectangular shape which is slightly smaller in overall height and width than the second half side wall 50. When the storage box 10 is assembled, the end of the first half side walls 46 slides into the opening created by the second half side walls 50 so that the first half side walls 46 and second half side walls 50 overlap each other when assembled. The first half side walls 46 fit closely inside of the second half side walls 50.

The first half side walls 46 and second half side walls 50 include lock openings 48 which receive the door lock tongues 44 and cooperate with the door locks 42 to lock the doors 34 closed. The first half side walls 46 and second half side walls 50 may also include screw holes 52. The screw holes 52 receive screws during installation of the locking storage box 10. When the locking storage box 10 is installed, a user will typically use metal screws to fasten the first half side walls 46 and the second half side walls 50 together. The user may also use screws to fasten the side walls 46, 50 to framing studs in the wall to further secure the locking storage box in the wall.

Before installation, the locking storage box 10 is provided with the front half 14 and the rear half 18 which are separate components. When installed into a wall, the storage box 10 front half 14 and rear half 18 a joined together. The first side walls 46 nest inside of the second side walls 50 and the side walls 46, 50 fit closely together and are fastened to each other to create a secure storage compartment 54. The storage compartment 54 is enclosed by the sidewalls 46, and by the front door 34 and rear door 34.

The storage box 10 may include gaskets/seals 58 which form a seal between the wall where the locking storage box 10 is installed and the frame 30/sidewall 46, 50 when the storage box is installed in a building wall. The locking storage box 10 may also include gaskets/seals 62 which seal between the door 34 and frame 30/sidewalls 46, 50 when the door 34 is closed. The storage box 10 may also include a gasket or seal between the overlapping sections of the sidewalls 46, 50. When the locking storage box 10 is installed and the doors 34 are closed, the storage compartment 54 is generally sealed from the environment on both sides of the wall.

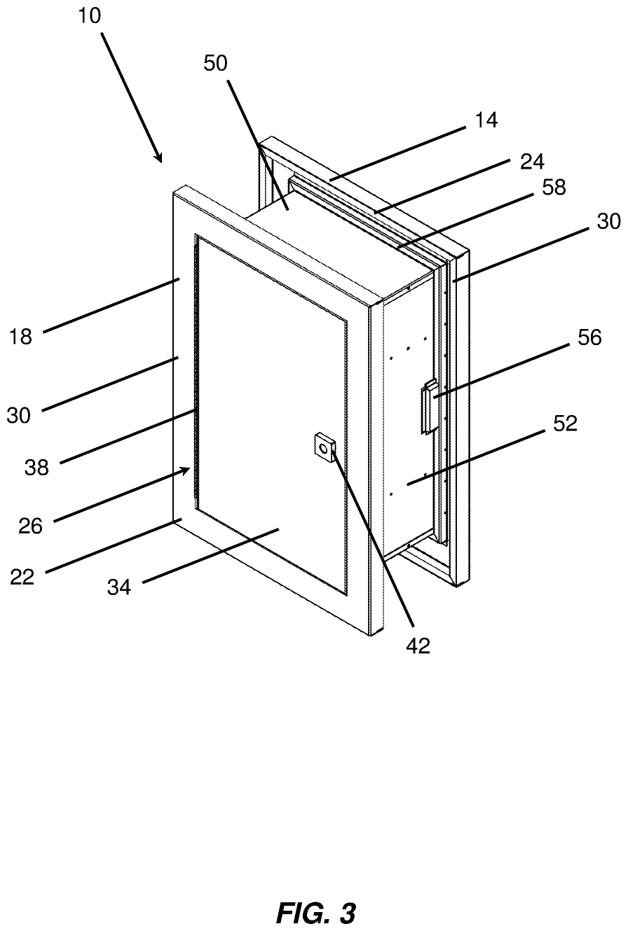

FIG. 3 shows a perspective view of the locking storage box 10 with the first half 14 and the second half 18 of the locking storage box 10 assembled together. The drawing shows the second half 18 of the locking storage box 10 is facing forwards to better show the door locks 42 and associated components. The first half side walls 46 have been moved inside of the space bounded by the second half side walls 50 until the space between the first and second frames 30 is equal to the thickness of a building wall. The locking storage box includes lock opening brackets 56 which are attached to the outside of the second half side walls 50 to cover the lock openings 48. The lock opening brackets 56 include a central plate which extends over and extends beyond the lock opening 48 and attachment legs which bend towards the side wall 50 and attach the lock opening brackets 56 to the side wall 50. The attachment legs space the central plate from the side wall 50 so that there is space between the side wall 50 and the central plate of the lock opening bracket 56. This space allows the lock tongue 44 to extend through the side wall 50 to a point beyond the outer surface of the side wall 50 and increases the reliability of the lock 42. The lock opening bracket 56 prevents installation of the locking storage box 10 in a position where the wall surface panel is pressed against the lock side surface of the side wall 50 and operation of the lock is prevented due to the lock tongue 44 contacting the wall panel.

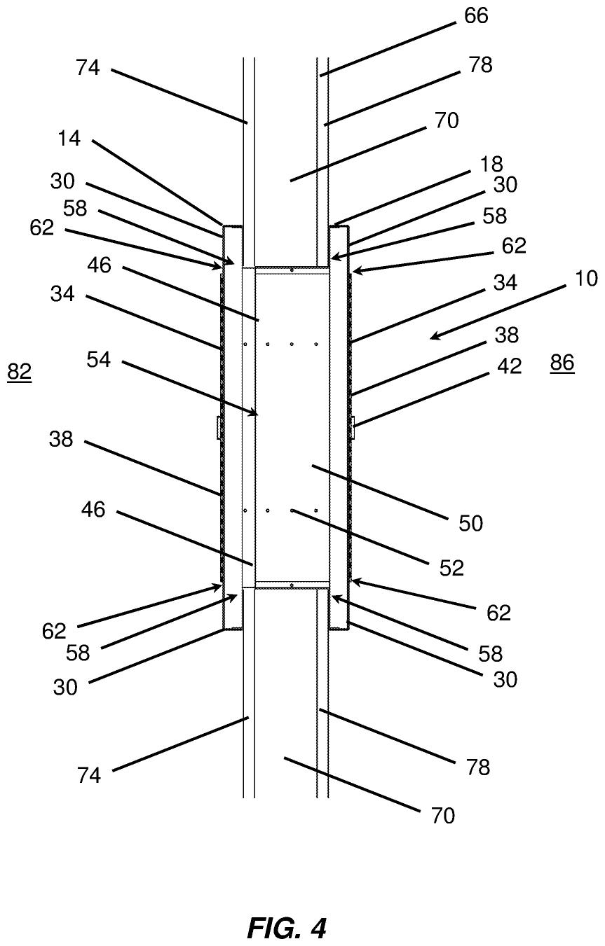

FIG. 4 shows a side view of the lockable storage box 10 mounted in a wall 66. The example wall is an exterior wall in a house. The wall 66 includes framing studs 70, an interior wall panel 74 such as sheetrock, and an exterior wall panel 78 such as plywood, siding, stucco, etc. The wall 66 is typically finished with paint or other finish coverings on the interior and exterior of the building. The lockable storage box 10 is provided in two pieces, a first half 14 and a second half 18 which are assembled together when the storage box 10 is installed in a wall. The lockable storage box 10 is attached to the wall 66 so that the frames 30 overlap the finished exterior panel 78 and interior panel 74 of the wall 66. The storage compartment side walls 46, extend towards the center of the wall 66 and overlap with each other.

The lockable storage box 10 may be added to a finished building wall 66 by cutting an appropriately sized hole in the wall 66, assembling the lockable storage box 10 into the wall 66, and attaching the lockable storage box 10 to the wall 66. The lockable storage box 10 may use fasteners which draw the first half 14 and the second half 18 towards each other and press the frames 30 against the wall 66. The lockable storage box 10 may use fasteners which pass through a hole in the frame 30 on the inside of the wall 66 and engage a threaded receptacle on the inner face of the outer frame 30. The lockable storage box 10 may also be attached to the wall 66 with fasteners which pass through holes 52 in the side walls 46, 50 and fasten the sidewalls 46, 50 to each other and, in many situations, to an adjacent wall framing stud 70. In many situations, an installer will cut the necessary opening in the wall 66, fit the second side 18 of the lockable storage box 10 into the opening, and fit the first side 14 of the lockable storage box 10 into the opening while sliding the first side walls 46 into the second side walls 50. The installer may open the doors 34 and use clamps to draw the first side 14 and second side 18 of the lockable storage box 10 towards each other and against the wall 66 and then fasten screws through side wall holes 52 to fasten the side walls 46, 50 to each other and to framing studs 70 where available. Often, the screws will drill new holes through one or both side walls 46, 50. These fastening arrangements secure the lockable storage box 10 to the wall and do not permit removal of the lockable storage box 10 without first accessing the inside of the box storage compartment 54.

In an installed configuration, the first side frame 30 and the second side frame 30 are positioned against the wall 66. The frames 30 extend beyond the side walls 46, 50 which define the storage compartment 54 and cover the edges of the cutout made in the wall 66. The locking storage box 10 may include seals 58 which seal against the wall 66. The outward faces of the first side 14 and second side 18 are generally flat and the frames 30 are low profile; typically between about one fourth and one half of an inch thick. The frames 30 are held flat against the wall 66. The storage compartment 54 is substantially limited to space within the wall 66 as the frames 30 and doors 34 are positioned adjacent the surfaces of the wall 66.

Once the lockable storage box 10 is assembled and fastened to the wall 66, the storage compartment 54 may be accessed through the doors 34 and may be secured by locking the doors 34 closed with the locks 42 to secure items in the storage compartment 54. The lock opening brackets 56 prevent interference between the lock tongues 44 and the wall panels 74, 78 and allow the lock tongue 44 to extend properly through the lock openings 48. The lockable storage box 10 may often be attached to an exterior wall of a residential building. In this situation, the storage compartment 54 may be accessed from either a space 82 which is inside of the building or a space 86 which his outside of the building.

The storage box 10 may be used to store items which should be kept secure from other individuals and which are commonly used outside of the house. For example, the storage box 10 may be used to store smoking or vaping supplies. In many instances, a household may include individuals who smoke or vape and other individuals who do not smoke or vape. In such a situation, people who do not smoke or vape often desire that the smoking supplies are stored in a location which keeps the smells and volatile chemicals outside of the house. Frequently, it is desirable to keep these supplies outside of the house. Similarly, households with young children often want to store smoking supplies in a location which keeps the supplies away from children. In such situations, there is often a desire for the smoking activity to occur outside of the house to keep the smoke and smells outside of the house.

The storage box 10 allows these items to be stored in a secure location where they are not accessible to minors or other unauthorized persons and prevents theft of the items. The storage box 10 allows a person to access the stored items from inside the house when needed, such as when purchasing and refilling/replenishing the smoking supplies. The storage box 10 allow a person to access the stored items from the outside of the house, such as when smoking or otherwise using the stored items. The person can use the stored items without inconvenience to others.

Smells and volatile chemicals from stored items do not leak into the building because of the seals 62 between the storage box body and the doors 34. Similarly, the door seals 62 keep rain and other inclement weather from damaging items stored in the box 10. The storage receptacle 54 is well isolated from the outside environment. The seals 58 provide a good seal between the storage box 10 and the wall 66. Additionally, caulk or other weatherproofing may be used when installing the storage box 10 into a building wall 66 to weatherproof the installation.

The above description of illustrated examples of the present invention, including what is described in the Abstract, is not intended to be exhaustive or to be limiting to the precise forms disclosed. While specific examples of the invention are described herein for illustrative purposes, various equivalent modifications are possible without departing from the broader scope of the present claims. Indeed, it is appreciated that specific example dimensions, materials, etc., are provided for explanation purposes and that other values may also be employed in other examples in accordance with the teachings of the present invention.

What is claimed is:

1. An in-wall storage box comprising:
a first storage box portion comprising:
a first frame surrounding a first opening;
a first door attached to the first frame which is movable between a first position where the first door closes the first opening and a second position where the first door permits access through the first opening;
a first lock which prevents unauthorized opening of the first door;
a first side wall section surrounding the opening and extending away from the first frame, wherein the first side wall extends around a storage compartment;
a second storage box portion which is separate from the first storage box portion, the second storage box portion comprising:
a second frame surrounding a second opening;
a second door attached to the second frame which is movable between a first position where the second door closes the second opening and a second position where the second door permits access through the second opening;
a second lock which prevents unauthorized opening of the second door;
a second side wall section surrounding the opening and extending away from the second face to extend around the storage compartment;
wherein the storage box is configured for attachment to a building wall having a first face and a second face such that:
the first frame is disposed adjacent the first face of the wall;
the second frame is disposed adjacent the second face of the wall;
the first side wall section and second side wall section are disposed adjacent each other in an interior of the wall wherein a distal end of one of the first side wall section and the second side wall section is disposed inside of a distal end of the other of the first side wall section and the second side wall section so that there is overlap between the first side wall section and the second side wall section; and
a storage compartment is formed between the first door, the second door, the first side wall section, and the second side wall section.

2. The in-wall storage box of claim 1, wherein the first door is openable to allow access into the storage compartment from inside of the building and the second door is openable to allow access into the storage compartment from outside of the building.

3. The in-wall storage box of claim 1, wherein the first lock includes a latch which extends through an opening in first side wall, and wherein the storage box comprises a lock opening bracket attached on the outside of the first side wall, the lock opening bracket comprising a plate which extends over the lock opening and is spaced apart from the exterior surface of the first side wall.

4. The in-wall storage box of claim 1, further comprising a fastener which penetrates the first side wall and the second side wall and which is installed from the storage compartment to join the first storage box portion and the second storage box portion.

5. The in-wall storage box of claim 1, wherein the first storage box portion and the second storage box portion are provided as separate components, and wherein the storage box is installed by inserting the first storage box portion into a wall opening from a first side of the wall, inserting the second storage box portion into the wall opening from a second side of the wall, and attaching the first storage box portion to the second storage box portion.

6. The in-wall storage box of claim 1, wherein the first frame comprises a shape and size which are the same as a shape and size of the second frame, and wherein the first door comprises a shape and size which are the same as a shape and size of the second door.

7. The in-wall storage box of claim 1, wherein the storage compartment is substantially contained within the wall.

8. The in-wall storage box of claim 1, wherein the first frame and the first door comprise a substantially planar front surface and wherein the second frame and the second door comprise a substantially planar front surface.

9. An in-wall storage box comprising:
a first storage box portion comprising a first face having a first opening and a first door attached to the first face, the first door being movable between a first position where the first door closes the first opening and a second position where the first door permits access through the first opening, a first lock which selectively restricts opening of the first door, and a first side wall which is attached to the first face, wherein the first side wall extends around the first opening and extends away from a back side of the first face and wherein the first side wall at least partially defines a storage compartment;
a second storage box portion which is separate from the first storage box portion, the second storage box comprising a second face having a second opening and a second door attached to the second face, the second door being movable between a first position where the second door closes the second opening and a second position where the second door permits access through the second opening, and a second lock which selectively restricts opening of the second door;
wherein, in use, the storage box is attached to a wall at a wall opening such that the first storage box face is attached to a first face of the wall, the first side wall extends into the opening, the second storage box face is attached to a second face of the wall, and the first storage box portion is attached to the second storage box portion.

10. The in-wall storage box of claim 9, further comprising a second side wall which is attached to the second face, wherein the second side wall extends around the second opening and extends away from a back side of the second face.

11. The in-wall storage box of claim 10, wherein the second side wall at least partially defines the storage compartment.

12. The in-wall storage box of claim 10, wherein the first side wall extends into the second side wall and wherein the first side wall is attached to the second side wall in the assembled storage box.

13. The in-wall storage box of claim 12, wherein the first side wall and second side wall are telescoping shapes.

14. The in-wall storage box of claim 12, wherein the first side wall and the second side wall are fastened to a wall stud in the assembled storage box.

15. The in-wall storage box of claim 9, wherein the storage compartment is substantially the same size as the opening in the wall.

16. The in-wall storage box of claim 9, wherein the first door is positioned parallel to and adjacent to the first face of the wall, and wherein the second door is parallel to and adjacent to the second face of the wall.

17. A lockable storage box comprising:
a first storage box portion comprising a first face having a first opening and a first door attached to the first face, the first door being movable between a first position where the first door closes the first opening and a second position where the first door permits access through the first opening, a first lock which selectively restricts opening of the first door, and a first side wall which is attached to the first face, wherein the first side wall extends around the first opening and extends away from a back side of the first face;
a second storage box portion comprising a second face having a second opening and a second door attached to the second face, the second door being movable between a first position where the second door closes the second opening and a second position where the second door permits access through the second opening, and a second lock which selectively restricts opening of the second door, and a second side wall which is attached to the second face, wherein the second side wall extends around the second opening and extends away from a back side of the second face;
wherein the first side wall has a shape which matches a shape of the second side wall, wherein the first side wall is smaller than the second side wall such that the first side wall is nestable inside of the second side wall in a telescoping manner, wherein the storage box is assembled by inserting the first side wall into the second side wall and fastening the first side wall to the second side wall such that a storage compartment is provided between the first face, the second face, the first side wall, and the second side wall, and wherein the first face is disposed on a side of the storage compartment opposite the second face.

18. The storage box of claim 17, wherein, in use, the storage box is attached to a wall at a wall opening such that the first storage box face is attached to a first face of the wall, the first side wall extends into the opening, the second storage box face is attached to a second face of the wall, and the second side wall extends into the opening.

19. The storage box of claim 18, wherein the first side wall and second side wall are fastened to a wall framing stud.
